(19) United States
(12) Patent Application Publication
(10) Pub. No.: US 2026/0208595 A1
(43) Pub. Date: Jul. 23, 2026

(54) MOBILE ROBOT ELECTRIC VEHICLE CHARGER WITH FIRE DETECTION FUNCTION

(71) Applicant: AHA CO., LTD., Gyeonggi-do (KR)

(72) Inventor: GI DO GOO, Seoul (KR)

(21) Appl. No.: 19/331,081

(22) Filed: Sep. 17, 2025

(30) Foreign Application Priority Data
Jan. 23, 2025 (KR) 10-2025-0010490

(51) Int. Cl. B60L 3/04; B60L 53/16; B60L 53/31; B60L 53/36; B60L 53/37; B60L 53/62; G05D 1/225; G05D 1/229; G08B 25/10; G08B 27/00; G08B 17/00

(52) U.S. Cl. CPC B60L 3/04; B60L 53/16; B60L 53/31; B60L 53/36; B60L 53/37; B60L 53/62; G05D 1/225; G05D 1/229; G08B 25/10; G08B 27/001; G08B 17/00

(57) ABSTRACT

A mobile robotic electric vehicle (EV) charger includes a body, a drive unit for autonomous movement, a charging unit to supply power to an EV, and a controller. The charger also includes a sensor unit with one or more of a flame sensor, a thermal sensor, and a camera sensor to monitor for a fire condition during a charging process. In response to detecting a fire, the controller is configured to immediately stop the charging process and transmit a fire alarm to a central server. The server, in turn, can relay the fire alarm to designated terminals, such as a management terminal or a fire department. The system provides an automated, convenient, and safe solution for EV charging by integrating real-time fire detection and emergency response capabilities.

### CROSS-REFERENCE TO RELATED APPLICATION AND CLAIM OF PRIORITY

This application claims priority under 35 U.S.C. §119 of Korean Patent Application No. 10-2025-0010490, filed on Jan 23, 2025, , in the Korean Intellectual Property Office, the entire disclosure of which is incorporated herein by reference for all purposes.

### BACKGROUND

### Field of the Invention

The present disclosure relates to the field of electric vehicle (EV) charging technology, and more specifically, to a mobile robotic electric vehicle charger having an integrated fire detection function for enhanced safety.

### Description of the Related Art

With the rapid proliferation of electric vehicles (EVs), the demand for efficient and accessible charging infrastructure has grown significantly. Conventional EV charging solutions primarily consist of stationary charging stations installed at fixed locations. This model requires a user to drive their vehicle to a specific charging station, which can be inconvenient and time-consuming. Furthermore, the limited number of chargers at a given station often leads to long waiting times, diminishing the overall user experience.

To address the limitations of fixed chargers, mobile robotic EV chargers have been introduced. These devices are designed to travel to a parked EV to provide charging services, thereby offering greater flexibility and convenience.

However, conventional mobile robotic chargers still face significant challenges, particularly concerning operational automation and safety. Many existing mobile chargers are manually operated or lack sophisticated safety protocols for the charging process. A critical area of concern is the risk of fire during EV charging. The high voltage and current involved in the charging process can create a potential fire hazard, posing a serious threat to the vehicle, its surroundings, and user safety.

Unfortunately, existing mobile charging robots are generally not equipped with adequate technology to detect and respond to a fire in real-time. They typically lack the integrated sensors and automated response mechanisms needed to immediately stop the charging process, alert relevant parties, and mitigate the danger upon the detection of a fire.

Therefore, there is a clear and unmet need in the art for an advanced mobile robotic EV charger that not only provides automated, on-demand charging but also incorporates a sophisticated fire detection and emergency response system. Such a technology would significantly enhance the safety and reliability of mobile EV charging infrastructure

### SUMMARY

The present disclosure provides a mobile robotic electric vehicle charger and a system thereof that overcomes the limitations and safety concerns of the related art. An object of the present disclosure is to provide a solution that combines the convenience of automated mobile charging with an advanced, integrated fire detection and response system to ensure high levels of safety and operational efficiency.

In an exemplary embodiment, a mobile robotic electric vehicle charger is provided. The charger includes a body housing a charger battery; a drive unit configured to move the charger to a target location; a charging unit, having a charging cable and a coupler, to supply power from the charger battery to an electric vehicle; a sensor unit including at least one of a camera sensor, a flame sensor, and a thermal sensor; and a controller.

The controller is configured to navigate the charger to a specific parking space where an EV is located, based on instructions from a server. Crucially, the controller is further configured to monitor sensor data from the sensor unit during the charging process. Upon detecting a fire condition, the controller immediately halts the charging process and transmits a fire alarm to the server, thereby preventing further escalation of the hazardous situation.

In another exemplary embodiment, an electric vehicle charging system is provided. The system includes a plurality of mobile robotic EV chargers as described above; one or more charging stations where the robotic chargers can standby and recharge their own batteries; and a central server in communication with the plurality of robotic chargers.

The server is configured to receive a charging request for a specific EV. In response, the server selects an available robotic charger and instructs it to travel to the EV's location. When the server receives a fire alarm from one of the robotic chargers, it is configured to transmit the alarm to one or more designated terminals, such as a management terminal, a fire department terminal, and a terminal of the EV's owner. The fire alarm may include information identifying the specific parking space where the fire was detected.

The mobile robotic charger of the present disclosure may exist in different configurations, including a manual type where a user connects the coupler, and an automatic type which includes a robotic arm. The robotic arm is configured to automatically connect the coupler to the EV's charging inlet and disconnect it upon completion of charging, based on vehicle information received from the server.

Accordingly, the present disclosure provides a significant technological advancement by creating a flexible and autonomous charging solution that proactively addresses the critical safety risks associated with EV charging. The integrated, real-time fire detection and multi-channel alert system ensures a rapid and coordinated response to emergencies, thereby protecting users, vehicles, and property.

### BRIEF DESCRIPTION OF THE DRAWINGS

The accompanying drawings, which are incorporated in and constitute a part of this specification, illustrate exemplary embodiments of the disclosure and, together with the description, serve to explain the principles of the disclosure.

FIG. 1 is a schematic diagram of a system including a mobile robotic electric vehicle charger, according to an exemplary embodiment.

FIG. 2 is a diagram illustrating a manual-type mobile robotic electric vehicle charger, according to an exemplary embodiment.

FIG. 3 is a flowchart illustrating a fire response algorithm for the manual-type mobile robotic electric vehicle charger, according to an exemplary embodiment.

FIG. 4 is a diagram illustrating an automatic-type mobile robotic electric vehicle charger, according to an exemplary embodiment.

FIG. 5 is a flowchart illustrating a fire response algorithm for the automatic-type mobile robotic electric vehicle charger, according to an exemplary embodiment.

FIG. 6 is a first exemplary view illustrating a method for guiding a coupler of the mobile robotic electric vehicle charger, according to an exemplary embodiment.

FIG. 7 is a second exemplary view illustrating a method for guiding a coupler of the mobile robotic electric vehicle charger, according to an exemplary embodiment.

### DETAILED DESCRIPTION

Various exemplary embodiments will now be described with reference to the accompanying drawings. In the following description, numerous specific details are set forth in order to provide a thorough understanding of the present disclosure. However, it will be apparent to one of ordinary skill in the art that the present disclosure may be practiced without these specific details.

The term "or" is intended to mean an inclusive "or" rather than an exclusive "or." That is, unless specified otherwise or clear from the context, the phrase "X uses A or B" is intended to mean any of the natural inclusive permutations. That is, if X uses A; X uses B; or X uses both A and B, then the phrase "X uses A or B" is satisfied under any of the foregoing instances. Furthermore, the term "and/or" as used herein is to be interpreted as encompassing any and all possible combinations of one or more of the associated listed items.

Further, the terms "comprises" and/or "comprising" specify the presence of stated features and/or components, but do not preclude the presence or addition of one or more other features, components, and/or groups thereof. In addition, as used herein and in the appended claims, the singular forms "a," "an," and "the" are intended to include the plural forms as well, unless the context clearly indicates otherwise.

The phrase "at least one of A and B" should be construed to mean "A alone," "B alone," or "a combination of A and B."

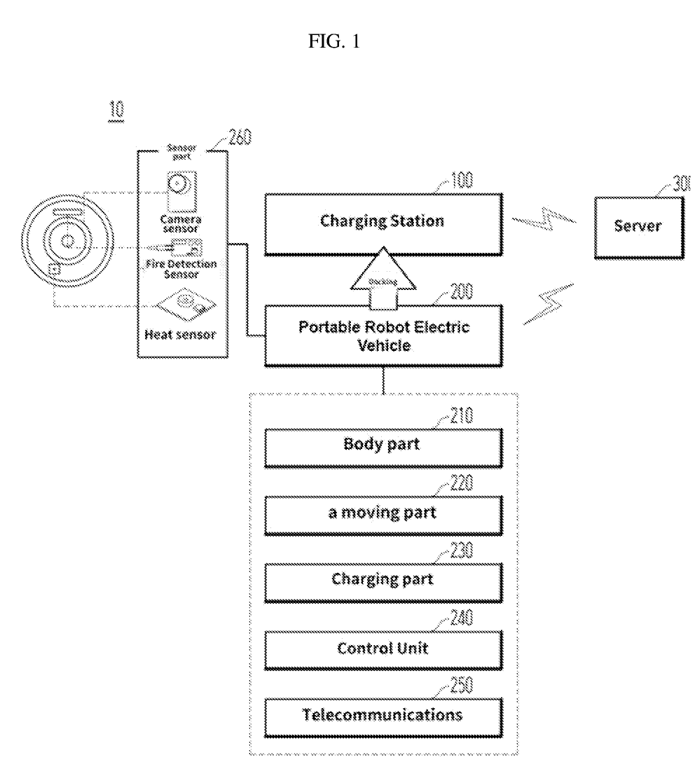

FIG. 1 is a schematic diagram of a system including a mobile robotic electric vehicle charger, according to an exemplary embodiment.

FIG. 1 illustrates a schematic diagram of a system 10 utilizing a mobile robotic electric vehicle charger 200, and describes in detail the components and operational method of the mobile robotic electric vehicle charger.

The mobile robotic electric vehicle charger 200 includes the following main components.

The body 210 serves as the basic structure of the mobile robotic electric vehicle charger, housing a charger battery and providing all the power necessary for the charging process. The body 210 supports other components such as the drive unit 220 and the charging unit 230. Furthermore, it is designed with durability and lightweight construction in mind to maintain stability during movement and operation.

The drive unit 220 is installed at a lower portion of the body 210 to enable the mobile robotic electric vehicle charger to move to a specific location. The drive unit 220 is composed of a driving motor, wheels, shock absorbers, and the like, and smoothly moves to the location where an electric vehicle is parked in accordance with instructions from the server 300.

The charging unit 230 is a device for supplying charging power to the electric vehicle, and its configuration varies depending on whether it is a manual type or an automatic type. The manual type includes a charging cable and a coupler, allowing a user to directly connect the coupler to the electric vehicle. The automatic type includes a robotic arm, which automatically connects or disconnects the coupler based on information about the EV's charging inlet position received from the server. The charging unit 230 is designed for high power efficiency and durability to ensure stable charging of the electric vehicle.

The controller 240 is a core component that controls the operation of the mobile robotic electric vehicle charger. The controller 240 communicates with the server 300 to coordinate all operations, including the charger's movement, initiation and termination of charging, and the operation of the robotic arm (in the case of the automatic type). Additionally, to enhance safety, it processes data provided by the sensor unit 260 in real-time to detect and respond to any abnormal situations that may occur during charging.

The sensor unit 260 includes a camera sensor, a flame sensor, and a thermal sensor, and monitors the safety of the charging environment. If a hazardous situation, including a fire, is detected, it cooperates with the controller 240 to stop the charging and transmit a fire alarm to the server 300.

The server 300 communicates with a plurality of mobile robotic electric vehicle chargers 200 to receive and process charging requests. When a charging request is received, the server selects the charger closest to a specific parking space and issues a move instruction to that location. It also controls the charger to return to the charging station 100 after charging is complete.

The charging station 100 is a place where the mobile robotic electric vehicle charger 200 waits and prepares for charging, and it provides the infrastructure for charging the battery of the mobile robotic electric vehicle charger.

The mobile robotic electric vehicle charger 200 moves to a specific parking space where a specific electric vehicle is parked according to instructions from the server 300, and the charging method differs depending on whether it is a manual type or an automatic type. The system 10 provides an efficient and safe charging service through the cooperation of a plurality of mobile robotic electric vehicle chargers and the server.

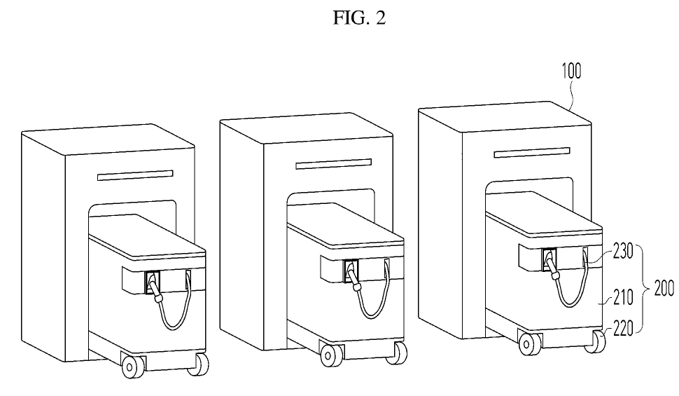

The aforementioned mobile robotic electric vehicle charger 200 is classified into a manual type and an automatic type. In the case of the manual type, the charging unit 230 includes a charging cable and a coupler, and it moves according to a move instruction from the server 300 to a specific parking space where a specific electric vehicle is parked, and returns to the charging station 100 if charging is not completed. On the other hand, in the case of the automatic type, the charging unit 230 is equipped with a robotic arm, which is used to attach the coupler to a specific electric vehicle, and after charging is complete, detaches the coupler and moves to the charging station. The manual and automatic types will be described based on FIGS. 2 to 4.

FIG. 2 is a diagram illustrating a manual-type mobile robotic electric vehicle charger, according to an exemplary embodiment.

Referring to FIG. 2, the manual-type mobile robotic electric vehicle charger is one of the main implementations of the present disclosure and supports the charging process through the interaction of its various components.

The manual-type mobile robotic electric vehicle charger includes a charging unit 230, a controller 240, a sensor unit 260, a body 210, and a drive unit 220. Each of these components performs individual functions while operating in an integrated manner to provide an efficient and stable charging environment.

The charging unit 230 is a core component for supplying charging power to an electric vehicle and includes a charging cable and a coupler. It is designed so that a user can initiate the charging process by directly connecting the coupler of the charging unit to the charging inlet of the electric vehicle. This charging unit maintains high power efficiency and is durable enough to operate stably over long-term use. Furthermore, the charging cable is manufactured with flexibility and strength in mind to minimize damage during use.

The controller 240 is a key component that manages and coordinates the operation of the mobile robotic electric vehicle charger. This controller communicates with the server 300 to centrally orchestrate tasks such as the charger's movement and the start and end of charging. In particular, the controller receives a user's charging request and, based on it, commands the charger to move to the correct location. It is also designed to monitor for any abnormal situations that may occur during charging and take appropriate action when necessary. This ensures both user safety and the efficiency of the charging process.

The sensor unit 260 serves to monitor the safety of the charging environment in real-time. This sensor unit includes a camera sensor, a flame sensor, and a thermal sensor to collect and analyze data in various ways. For example, if a fire occurs or an abnormality in the charging environment is detected, the sensor unit immediately sends a signal to the controller 240 to stop the charging and transmits the relevant information to the server 300. This minimizes potential risks during the charging process and maximizes user safety.

The body 210 provides the structural foundation of the charger, houses the charger battery, and supports other components such as the drive unit 220 and the charging unit 230. The body is made of a lightweight material to enhance mobility while also having strong durability against external impacts. The drive unit 220 includes a driving motor and wheels to support the charger's accurate movement to a designated parking space. The drive unit operates based on path data provided by the server 300 and precisely controls the charger's speed and direction.

The manual-type mobile robotic electric vehicle charger provides an intuitive interface that is easy for users to operate and is designed with a simple operational method. When a user inputs a charging request and completes payment, the charger moves to the designated location to prepare for charging. After charging is finished, the charger automatically returns to the charging station 100 to prepare for the next charge.

This manual-type mobile robotic electric vehicle charger is designed based on reliability and stability, allowing it to be flexibly used in various charging environments. Furthermore, through its user-friendly design and safety-conscious technical implementation, it significantly enhances the electric vehicle charging experience. This contributes to increasing the convenience and satisfaction of EV users while also contributing to the establishment of an efficient charging infrastructure.

In one embodiment, the manual-type mobile robotic electric vehicle is designed to maintain a brake on a slope. The charger can sense gravity on its own and automatically activates the brake to prevent unintended movement on a slope. However, if a user grabs a handle and applies external force to move the charger, the charger detects the user's intent to move via a sensor embedded in the handle. This allows the charger to move in the direction of the applied force, enabling it to be maneuvered forward or backward according to the user's intention.

For example, when the charger is moving to charge an electric vehicle located on a sloped parking space, if the user grabs the handle and pushes it forward, the charger releases the brake and moves in the designated direction. Conversely, if the external force is removed or the user lets go of the handle, the charger immediately stops, and the brake is reactivated to ensure safety. This design guarantees safe operation on slopes while also being optimized to support intentional movement by the user.

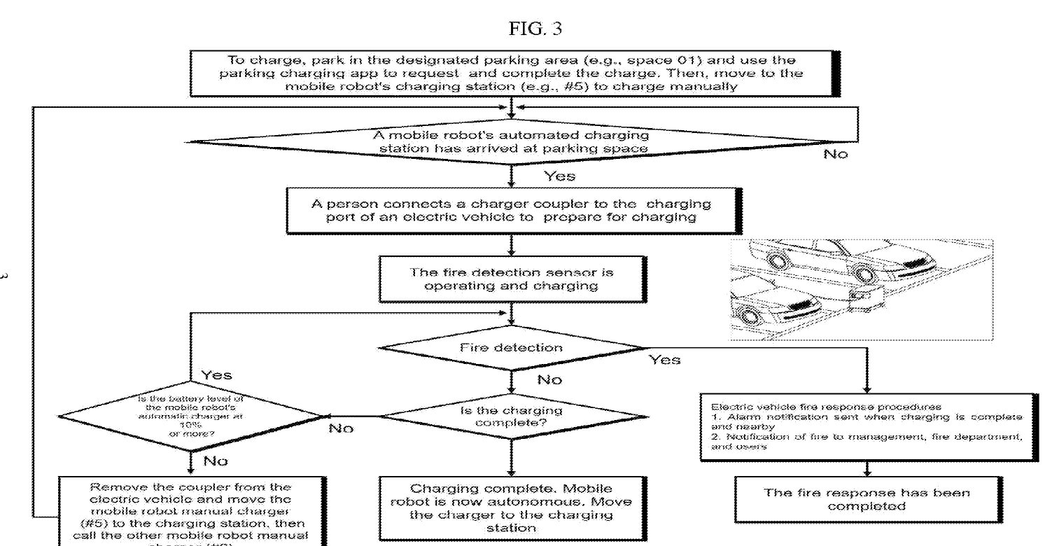

FIG. 3 is a flowchart illustrating a charging and fire response algorithm for the manual-type mobile robotic electric vehicle charger, according to an exemplary embodiment.

Referring to the flowchart in FIG. 3, the charging algorithm is described as follows. When a user parks an electric vehicle in a parking space and completes payment for charging, the request is transmitted to the server 300, which then summons a manual-type mobile robotic electric vehicle charger 200 to the parking space. The manual-type charger 200 moves to the parking space, and a person opens the charging inlet of the electric vehicle and inserts the coupler to complete the preparation for charging. Simultaneously, the sensor unit 260 activates, and if no fire is detected, the charging process begins. When charging is complete, the manual-type charger 200 moves to a charging station to recharge its own battery. Furthermore, if the battery capacity of the manual-type charger 200 falls below 10% during charging, the server 300 may summon another manual-type charger 200 as a replacement to complete the remaining charge.

The fire detection and response algorithm executes response procedures in a fire situation, centered on the interaction between the sensor unit 260 and the server 300.

In one embodiment, the mobile robotic electric vehicle charger 200 monitors data in real-time through the sensor unit 260 to detect a fire during charging. The sensor unit 260 includes a camera sensor, a flame sensor, and a thermal sensor, each capable of detecting abnormal temperature rises, sparks, or smoke that may occur in the charging environment. For example, if the thermal sensor detects that the temperature around the charger exceeds a predetermined threshold, the sensor unit immediately transmits a signal to the controller 240.

When a fire is detected, the mobile robotic electric vehicle charger 200 immediately stops the charging process and transmits alarm data, including the location of the fire, to the server 300. The server then receives the fire alarm and transmits this information to a management terminal, a fire department terminal, and the vehicle owner's terminal for the vehicle parked in that space. Additionally, the charger may emit an alarm in the vicinity of the charging EV to alert nearby users to the fire hazard. This enables a swift response to the fire situation.

As a specific example, a situation may be assumed where a mobile robotic electric vehicle charger 200 charging in a specific parking space detects a high-temperature condition via its thermal sensor. The charger immediately stops charging and transmits a fire alarm, including the parking space number (e.g., No. 15), to the server 300. After receiving the alarm, the server displays the fire alarm on the management terminal and simultaneously forwards the alarm to the fire department terminal and the terminal of the owner of the vehicle in parking space 15. During this process, the mobile robotic electric vehicle charger moves to a safe area and displays a warning message such as "FIRE DETECTED, DO NOT APPROACH" on its display panel to inform people nearby of the fire. Such a message on the display panel may also include additional information to guide fire response personnel to the location of the fire.

The flowchart of FIG. 3 includes the following steps.

In a first step, the sensor unit 260 collects data from the charging environment in real-time. The sensor unit 260, including the camera sensor, flame sensor, and thermal sensor, monitors for any abnormal conditions that may arise during charging. The collected data is transmitted to the controller 240 for further analysis.

In a second step, if the sensor unit detects a fire, the controller 240 immediately stops the charging. This process is designed with safety as the top priority, allowing subsequent actions to begin immediately after charging is halted. If no fire is detected, charging continues normally.

In a third step, data related to the location of the fire is transmitted to the server 300. This data includes the parking space number, temperature change values, and other relevant information, which the server processes in preparation for transmission to the appropriate authorities.

In a fourth step, the server transmits the fire alarm to the management terminal, the fire department terminal, and the vehicle owner's terminal for the relevant parking space. This alarm includes the fire location, parking space number, and additional emergency information so that each party can respond quickly.

In a fifth step, the mobile robotic electric vehicle charger 200 moves to a safe area. Simultaneously, it displays a warning message such as "FIRE DETECTED, DO NOT APPROACH" on its display panel to alert people in the vicinity to the fire. This warning plays a crucial role in informing people of the situation in the time before fire response personnel arrive on the scene.

In a final step, a full-scale fire response procedure is initiated via the management and fire department terminals. Until response personnel arrive, the charger may continue to detect additional risk factors or transmit relevant data to the server. This process helps to minimize risks and supports the smooth execution of the fire response operation.

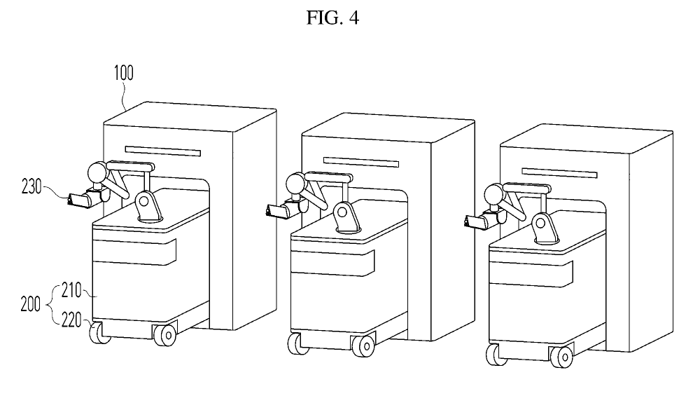

FIG. 4 is a diagram illustrating an automatic-type mobile robotic electric vehicle charger, according to an exemplary embodiment.

Referring to FIG. 4, the automatic-type mobile robotic electric vehicle charger is one of the main implementations of the present disclosure, designed to automatically perform the charging of an electric vehicle without user intervention. This charger is characterized by the automation of the charging process and significantly enhanced safety.

The automatic-type mobile robotic electric vehicle charger is composed of a charging unit 230, a controller 240, a sensor unit 260, a body 210, and a drive unit 220. Each of these components interoperates to provide an efficient and safe charging service. The charging unit 230 includes a charging cable and a robotic arm. The robotic arm performs the task of accurately identifying the position of the electric vehicle's charging inlet and connecting the coupler based on data received from the server 300. This robotic arm uses high-precision sensors to check the shape and position of the charging inlet in real-time and attaches the coupler at the optimal position. When charging is complete, the robotic arm safely disconnects the coupler to terminate the charging process.

The controller 240 is the core control device of the automatic-type charger and coordinates all of its operational processes. The controller 240 communicates with the server 300 to confirm the EV's model information and charging inlet location, and based on this, it optimizes the charger's travel path. Furthermore, the controller is designed to detect and respond in real-time to any risk factors that may arise during the charging process.

The sensor unit 260 is a device for monitoring the safety of the charging environment and the charging process, and it includes a camera sensor, a flame sensor, and a thermal sensor. These sensors detect in real-time any abnormal signs that may occur during charging, such as temperature rises, sparks, or smoke. In the event of a fire or other abnormal situation, the sensor unit 260 cooperates with the controller 240 to immediately stop the charging and transmit an alarm to the server 300. This minimizes potential risks that can occur during the charging process.

The body 210 provides the physical structure of the charger and houses the charger battery. The body 210 supports the drive unit 220 and the charging unit 230 and possesses strong durability against external impacts. The drive unit 220 includes a driving motor and wheels and is designed to allow the charger to move smoothly to a parking space according to instructions from the server 300. This drive unit ensures the smooth movement of the charger through functions such as detecting and avoiding obstacles or searching for a detour path.

In one embodiment, the automatic-type mobile robotic electric vehicle charger receives a charging request from the server 300 to charge an electric vehicle parked in a specific parking space. The server transmits the EV's model information and charging inlet location along with the charging request to the controller 240. The controller 240 moves the charger to the corresponding parking space via the drive unit 220 and uses the robotic arm to open the charging inlet and connect the coupler. During the charging process, the sensor unit 260 continuously monitors the charging environment, and if no abnormal situation occurs, completes the charge. Once charging is finished, the robotic arm disconnects the coupler, and the charger returns to the charging station.

For example, if an electric vehicle is parked in parking space No. 10, the automatic-type mobile robotic electric vehicle charger receives this information from the server and moves to parking space No. 10. When the charger arrives, the robotic arm identifies the EV's charging inlet according to the data received from the server and connects the coupler accurately. While the charging process is underway, the sensor unit continuously monitors the charging environment. If it detects abnormal signs such as a temperature rise or sparks, it immediately stops the charging and takes safety measures. Through this series of processes, the automatic-type mobile robotic electric vehicle charger performs safe and efficient charging without user intervention.

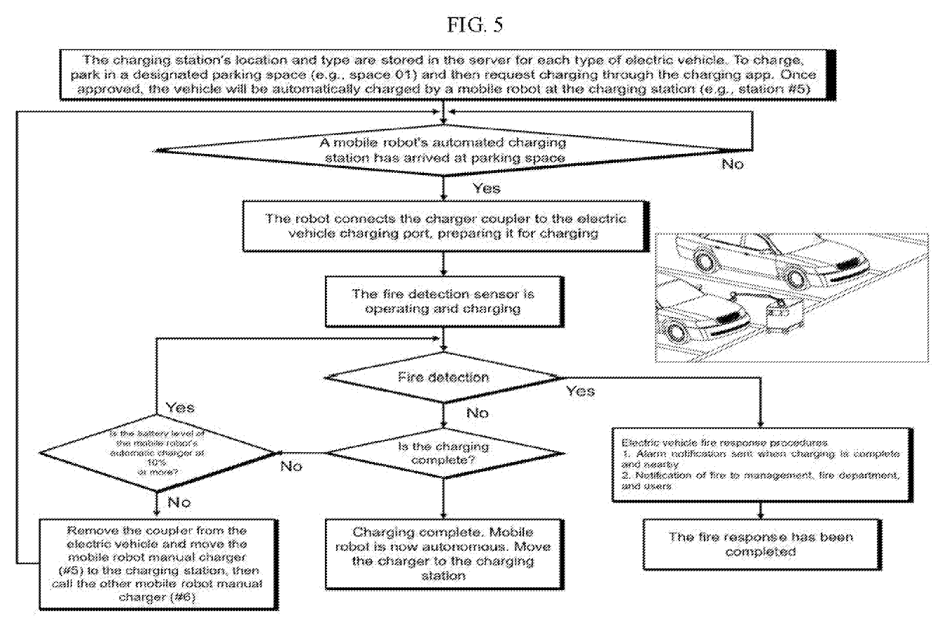

FIG. 5 is a flowchart illustrating a charging and fire response algorithm for the automatic-type mobile robotic electric vehicle charger, according to an exemplary embodiment.

Referring to the flowchart in FIG. 5, the charging algorithm is described as follows. When a user parks an electric vehicle in a parking space and completes payment for charging, the request is transmitted to the server 300, which then summons an automatic-type mobile robotic electric vehicle charger 200 to the parking space. The automatic-type charger 200 moves to the parking space, where its robotic arm finds the electric vehicle's charging inlet, opens the cover, and inserts the coupler to complete the preparation for charging. Simultaneously, the sensor unit 260 activates, and if no fire is detected, the charging process begins. When charging is complete, the automatic-type charger 200 moves to a charging station to recharge its own battery. Furthermore, if the battery capacity of the automatic-type charger 200 falls below 10% during charging, the server 300 may summon another automatic-type charger 200 as a replacement to complete the remaining charge.

The fire detection and response algorithm proceeds with response procedures in a fire situation, centered on the interaction between the sensor unit 260 and the server 300. It outlines the steps for how the charger and the system interact to effectively respond when a fire is detected, by monitoring for potential fires in real-time during the charging process.

The automatic-type mobile robotic electric vehicle charger features an advanced design that uses a robotic arm to attach or detach the coupler from the vehicle's charging inlet during the charging process. To begin charging, the robotic arm, included in the charging unit 230, accurately identifies the position of the vehicle's charging inlet and connects the coupler. After charging is finished, the same robotic arm safely disconnects the coupler to complete the charging process. This automated process enables stable and rapid charging without user intervention.

The automatic-type mobile robotic electric vehicle charger is designed for immediate response in the event of a fire through the cooperation of the sensor unit 260, the controller 240, the server 300, and the charging unit 230. This algorithm focuses on securing the safety of the user and the surrounding environment in an emergency situation such as a fire.

In a first step, the sensor unit 260 collects data from the charging environment in real-time. The sensor unit 260 detects abnormal signs that may occur during charging, such as temperature rises exceeding a certain threshold (detected by the thermal sensor) or sparks and smoke (detected by the flame sensor), and transmits the data to the controller 240.

In a second step, if a fire is detected by the sensor unit, the controller 240 immediately stops the charging process. This step is designed with the safety of both the electric vehicle and the charger as the top priority, preparing for subsequent actions as soon as the charging process is halted.

In a third step, the controller 240 transmits a fire alarm to the server 300. This alarm includes the location of the fire (e.g., parking space number), the detected temperature, and other relevant data. The server processes this information and promptly sends it to a management terminal, a fire department terminal, and the terminal of the EV owner in that parking space. This allows each party to respond immediately to the fire.

In a fourth step, the mobile robotic electric vehicle charger 200 moves away from the charging area to a pre-designated safe area. During this movement, the charger's display panel shows a warning message such as "FIRE DETECTED, DO NOT APPROACH" or "FOR FIRE PERSONNEL ONLY" to alert people in the vicinity. This is designed to prevent further accidents and provide necessary information to fire response personnel.

In a fifth step, the server 300 initiates the formal fire response procedure through the fire response personnel and management terminals. During this process, the charger continuously monitors environmental data and sends additional information to the server if necessary, for example, by detecting the spread of the fire or continuously checking for temperature changes in the surrounding environment.

For example, a case can be considered where an automatic-type mobile robotic electric vehicle charger, while charging in parking space No. 12, detects a temperature rise via its thermal sensor. The sensor unit 260 immediately reports this to the controller 240, which stops the charging and sends the fire location information to the server 300. The server sends an alarm to the fire department and the management office, while also sending a notification to the vehicle owner. The charger immediately moves to a safe area and displays a warning message on its display panel. Through such a series of processes, user safety and damage to facilities can be minimized even in a fire situation.

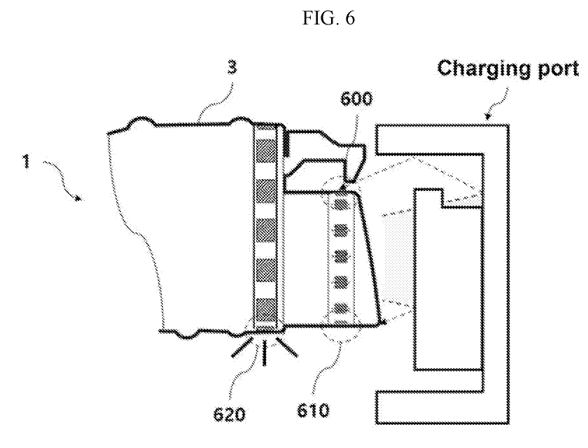

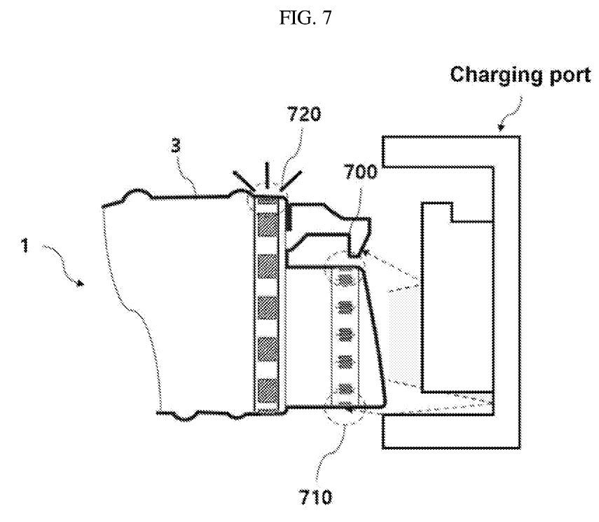

FIG. 6 is a first exemplary view illustrating a method for guiding a coupler of the mobile robotic electric vehicle charger, and FIG. 7 is a second exemplary view illustrating the method for guiding the coupler.

An EV charging coupler is broadly composed of an EV connection part, a housing, a controller, an LED light-emitting unit, and an optical sensor unit. The EV connection part connects to the main body of the charger and serves to supply power, through which electrical energy is transferred to the EV. The design of this part may vary depending on the EV model. The housing is a protective structure that encases the coupler, protecting the internal electrical components. The controller is an electronic circuit that manages and controls the various functions of the coupler, such as controlling the illumination of the LED light-emitting unit, monitoring the charging status, and handling communication functions, and may additionally include a memory and a network unit.

The LED light-emitting unit performs two main functions. The first is to visually indicate the status of the coupler to inform the user of the charging status, which may be a ring shape including LEDs formed continuously at certain angular intervals. The second is to provide visual guidance to the user by emitting light toward the charging inlet. Especially at night or in dark environments, the LED light-emitting unit helps to easily identify the location of the charging inlet. This allows the user to accurately insert the coupler into the EV charging inlet, preventing charging failures or equipment damage due to incorrect connection.

The optical sensor unit is a sensing device integrated into the coupler that detects the amount of ambient light in real-time to efficiently control the LED light-emitting unit. The optical sensors are arranged at certain angular intervals to form a ring shape and measure the illuminance level around the charging inlet to automatically adjust the brightness of the LED light-emitting unit. Furthermore, if the position of the coupler needs to be adjusted, it illuminates the LEDs to inform the user of the direction in which to move the coupler. The operation of this optical sensor unit is performed in conjunction with the controller.

The EV charging coupler includes safety features such as insulation treatment, overheat prevention, and waterproof functions to ensure user safety. This contributes to minimizing electrical hazards that can occur during charging. Additionally, the coupler with built-in LEDs and sensors provides the convenience of easily connecting the EV charging inlet and the coupler even at night or in dark environments. The coupler is manufactured according to international standards and is compatible with EVs from various manufacturers. Representative standards include Type 1, Type 2, CHAdeMO, and CCS, and the main embodiments of the present disclosure can be implemented regardless of the type of these standards.

In one embodiment, the controller may, at predetermined time intervals, select a specific first LED located in the opposite direction based on a first optical sensor that measures the lowest amount of light among the plurality of optical sensors included in the coupler, and cause the specific first LED to emit light.

As shown in FIG. 6, consider a case where the coupler of the present disclosure is positioned above the optimal location for coupling with the charging inlet. In this situation, the optical sensor at the 90-degree position (index a', 600) may receive the most light, while the optical sensor at the opposite 180-degree position (index e', 610) may receive the least light. In this case, the controller 2 may, based on the optical sensor at the 180-degree position (index e'), select and illuminate the LED at the 90-degree position (index a, 620) located on the opposite side. Furthermore, an N value is calculated according to the difference in light intensity, and N additional LEDs on each side are also illuminated. For example, if the N value is calculated as 2, LEDs from index g to c may also be illuminated. The user then uses the illuminated LEDs as a visual guide to rotate the coupler so that the LED at the 0-degree position points toward the charging inlet. This allows for the accurate insertion of the coupler into the electric vehicle's charging inlet.

Conversely, as shown in FIG. 7, consider a case where the coupler 1 of the present disclosure is positioned below the optimal location for coupling with the charging inlet. In this situation, the optical sensor at the 180-degree position (index e', 710) may receive the most light, while the sensor at the opposite 90-degree position (index a', 700) may receive the least light. In this case, the controller 2 may, based on the optical sensor at the 90-degree position (index a'), select and illuminate the LED at the 180-degree position (index e, 720) located on the opposite side. Furthermore, an N value is calculated according to the difference in light intensity, and additional LEDs are illuminated accordingly. For example, if the N value is calculated as 2, LEDs from the 270-degree position (index g) to the 180-degree position (index c) may also be illuminated. The user then uses the illuminated LEDs as a visual guide to rotate the coupler 1 so that the LED at the 270-degree position points toward the charging inlet. This allows for the accurate insertion of the coupler 1 into the electric vehicle's charging inlet.

In other words, the user can align the coupler 1 in the direction indicated by the illuminated LEDs and can also determine how much to move the coupler 1 based on the number of illuminated LEDs.

In a further embodiment, in the case of an automatic-type mobile robotic electric vehicle charger, the robotic arm can adjust the position of the coupler in the direction indicated by the LEDs during the process of inserting the coupler into the charging inlet. In this case, the robotic arm tracks the direction of the LEDs in real-time based on data from the controller and the sensor unit 260, precisely adjusting the angle and position of the coupler to achieve perfect alignment with the charging inlet. This allows for a more efficient and rapid automatic connection to the charging inlet.

Hereinafter, additional embodiments applicable to the present disclosure are disclosed.

In one embodiment, a plurality of coupler types that can be attached to the charging unit are mounted on the upper part of the mobile robotic electric vehicle charger. For example, a case may be considered where the mobile robotic EV charger is designed to be compatible with various EV models. In this embodiment, various couplers that comply with international standards such as Type 1, Type 2, CHAdeMO, and CCS are provided. When a user requests charging, the robotic EV charger communicates with the server to confirm the EV's model information and automatically selects and attaches the appropriate coupler for that model. In this process, the server may estimate the vehicle model based on the license plate number or an external image of the EV to be charged. The server may instruct the mobile robotic EV charger to use a predetermined type of coupler according to the vehicle model.

For example, assume a user sends a charging request for an EV that uses the Type 2 standard. The server processes the request and instructs the robotic EV charger to select the Type 2 coupler. The Type 2 coupler from the coupler module mounted on the upper part of the robotic EV charger is automatically selected and attached to the charging inlet via the robotic arm. When charging is complete, the robotic arm detaches the coupler and returns it to its original position.

As another example, if a robotic EV charger is equipped with both Type 1 and CCS couplers simultaneously, it can selectively provide the appropriate coupler for each vehicle model at a charging station where multiple EVs are parked. In this process, the robotic EV charger precisely detects the position and shape of the charging inlet through the sensor unit and controller to stably attach the suitable coupler. This allows users to complete charging quickly and safely without coupler compatibility issues.

Such a system for mounting multiple coupler types increases the efficiency of the charging station, ensures compatibility with various EV models, and provides the convenience of not requiring users to prepare separate equipment. Furthermore, the intelligent control system of the robotic EV charger automates the coupler selection and attachment process, further enhancing the accuracy and reliability of the charging operation.

In another embodiment, the robotic EV charger includes a display panel to respond swiftly to emergency situations such as a fire. Consider a case where the robotic EV charger detects a fire. When the sensor unit detects heat, flames, or smoke, the controller immediately stops the charging and displays a fire warning message on the display panel. For example, a message such as "FIRE DETECTED: DO NOT APPROACH" warns the user and people nearby of the dangerous situation. Simultaneously, the robotic EV charger automatically moves to a predetermined parking lot entrance or emergency evacuation route and provides real-time movement information to people nearby by displaying a message such as "FIRE DETECTED: MOVING TO SAFE AREA" on its display panel.

In yet another embodiment, the robotic EV charger uses its built-in camera to identify evacuees and support rescue operations. During a fire response, it captures real-time video of people in the vicinity, and if the same person is repeatedly identified, it records their path of movement. For example, after the charger first detects a person A at a specific location, it saves their travel path as data and continuously tracks whether they have evacuated to a safe area. This movement tracking can be usefully applied not only for tracking evacuees but also for locating missing persons or identifying individuals remaining in a hazardous area during rescue operations.

This system is not limited to simply tracking evacuee movements but can also identify abnormal behaviors or congestion on evacuation routes to provide additional warnings. For example, if a person stops on an evacuation route or moves in a different direction, the charger transmits this information to the server and displays a message such as "EVACUATION HALTED: ROUTE CHECK NEEDED" on the display panel to prompt immediate action. Furthermore, the recorded movement data can be used as analysis material after the emergency situation has ended to contribute to improving the response process for similar future incidents.

These functions allow the robotic EV charger to perform a role beyond that of a simple charging device in emergency situations like a fire, playing an important role in comprehensively ensuring the safety of users and the surrounding environment.

In another embodiment, the fire warning message displayed on the display panel when the robotic EV charger detects a fire can be designed to include the identification number of the area where the fire occurred. For example, if a fire occurs in parking space No. 15, the message "FIRE DETECTED: ZONE 15, DO NOT APPROACH" is displayed on the panel. This allows people nearby and fire response personnel participating in the rescue operation to immediately identify the exact location of the fire. This information increases the efficiency of rescue operations and contributes to improving the response speed in emergency situations.

In a further embodiment, if a specific robotic EV charger identifies a fire, all robotic EV chargers within the charging station can be designed to automatically move to an area safe from the fire. For example, if the robot charger in zone 10 detects a fire, that charger immediately transmits the fire information to the server. The server receives this and sends a command to stop charging along with an emergency move instruction to all other chargers in the station. Each charger then moves to a pre-set safe area, displaying a message such as "FIRE DETECTED: MOVING TO SAFE AREA" on its display panel during the move to provide a warning to nearby users. Such a system prevents equipment loss in the event of a fire and plays a significant role in securing evacuation routes to support people's safety.

In another embodiment, if the robotic EV charger detects that a vehicle is not parked correctly within the parking lines while moving, it can be designed to send a notification message to the vehicle owner. For example, if a camera sensor detects a vehicle that is outside the parking lines, the controller identifies the vehicle's license plate information and sends it to the server. The server then sends a notification to the vehicle owner, such as "You have parked outside the designated area. Please reposition your vehicle." This allows for the efficient management of the charging space and secures space to be provided to other users. Additionally, records of repeatedly improperly parked vehicles can be maintained to increase management efficiency.

In yet another embodiment, if the robotic EV charger detects an obstacle while moving, it can be designed to automatically search for a detour path or transmit information about the obstacle to the server. If an obstacle is blocking the charging location, the robot charger reports this to the management office and captures and sends a photo of the obstacle using its built-in camera. For example, if the charger detects a vehicle occupying a charging space, the server reports this to the management office and sends a request to the vehicle owner to move the vehicle, including a photo and a description of the situation. Furthermore, in situations where the charger cannot find a detour, it can automatically send an obstacle removal request to the management office to prompt swift action. This helps to ensure the smooth operation of the charging location and minimizes charging delays caused by obstacles.

The embodiments of the present disclosure have been presented for illustrative purposes only, and the entire scope of the present disclosure is not limited to these specific embodiments. The present disclosure can be modified and varied in numerous ways based on the above-described embodiments, and such variations also fall within the technical spirit and scope of the present disclosure. Therefore, the present disclosure may be embodied in many different forms within the scope of the claims, and is not limited to the embodiments set forth herein, and various applications are possible.

What is claimed is:

1. A mobile robotic electric vehicle charger comprising:
a body configured for housing a charger battery;
a drive unit installed at a lower portion of the body;
a charging unit having a charging cable and a coupler configured to supply power from the charger battery to an electric vehicle; and
a controller configured to:
navigate the mobile robotic electric vehicle charger to a specific parking space where a specific electric vehicle is parked, based on a move instruction from a server; and
in a state where the coupler is not coupled to the specific electric vehicle, navigate the mobile robotic electric vehicle charger to a charging station in response to determining that the specific electric vehicle is fully charged or that a remaining charge of the charger battery is below a predetermined threshold.

2. A mobile robotic electric vehicle charger comprising:
a body configured for housing a charger battery;
a drive unit installed at a lower portion of the body;
a charging unit comprising a robotic arm configured to move a coupler for supplying power from the charger battery to an electric vehicle; and
a controller configured to:
navigate the mobile robotic electric vehicle charger to a specific parking space where a specific electric vehicle is parked, based on a move instruction from a server;
cause the robotic arm to attach the coupler to the specific electric vehicle; and
in response to determining that charging of the specific electric vehicle is complete or that a remaining charge of the charger battery is below a predetermined threshold, cause the robotic arm to detach the coupler and navigate the mobile robotic electric vehicle charger to a charging station.

3. An electric vehicle charging system comprising:
a plurality of charging stations;
a plurality of mobile robotic electric vehicle chargers; and
a server configured to communicate with the plurality of mobile robotic electric vehicle chargers,
wherein the server is configured to:
receive a charging request for a specific electric vehicle;
select a specific mobile robotic electric vehicle charger from the plurality of mobile robotic electric vehicle chargers that is located at one of the charging stations; and
instruct the selected specific mobile robotic electric vehicle charger to move to a specific parking space where the specific electric vehicle is parked,
wherein each of the plurality of mobile robotic electric vehicle chargers comprises a sensor unit including a camera sensor, a flame sensor, and a thermal sensor, and is configured to:
obtain sensing data from the sensor unit;
detect a fire based on the sensing data; and
in response to detecting the fire:
stop charging the specific electric vehicle; and
transmit a fire alarm to the server, the fire alarm comprising parking space information corresponding to a location where the fire was detected,
wherein the server is further configured to, in response to receiving the fire alarm, transmit the fire alarm to at least one of a management terminal, a fire department terminal, and a vehicle owner terminal of a vehicle parked in the location where the fire was detected.
